(19) United States
(12) Patent Application Publication
(10) Pub. No.: US 2026/0320861 A1
(43) Pub. Date: Oct. 15, 2026

(54) LARGE MULTIMODAL MODEL FINE-TUNING FOR MODEL RECOGNITION

(71) Applicant: Beijing YoJaJa Software Technology Development Co., Ltd., Beijing (CN)

(72) Inventors: Shuai Lou, Beijing (CN); Kui Wang, Beijing (CN); Jun Sun, Beijing (CN); Mo Cheng, Beijing (CN)

(73) Assignee: Beijing YoJaJa Software Technology Development Co., Ltd., Beijing (CN)

(21) Appl. No.: 19/174,633

(22) Filed: Apr. 9, 2025

(51) Int. Cl. G06T 11/60

(52) U.S. Cl. CPC G06T 11/60

(57) ABSTRACT

In some embodiments, a method receives a plurality of images of objects and object names. A plurality of synthetic images is generated where a synthetic image includes a combination of images of objects from the plurality of images of objects. The method generates corresponding text instructions and ground truths for the plurality of synthetic images based on respective object names of the combination of images of objects. A synthetic image is input from the plurality of synthetic images and a corresponding text instruction into a large multimodal model. The large multimodal model generates a response using the synthetic image and the corresponding text instruction. The method compares the response to a corresponding ground truth for the corresponding text instruction to adjust a parameter of the large multimodal model based on a difference between the response and the corresponding ground truth.

### BACKGROUND

A model may be trained to generally recognize objects in an image. However, a company may want to train the model to recognize specific objects. This may require fine-tuning of parameters of the model. To fine-tune the model, images of the specific objects are required; however, it may be hard to find enough images of the specific objects. When not enough images are found, then the fine-tuning may not be sufficient to train the model to accurately recognize the specific objects.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for detecting objects in an image according to some embodiments.

FIG. 2 depicts a more detailed example of training a large multimodal model according to some embodiments.

FIG. 3 depicts an example of generating synthetic images according to some embodiments.

FIG. 4 depicts a simplified flowchart of a method for generating a training dataset according to some embodiments.

FIG. 5 depicts a simplified flowchart of a method for training the large multimodal model according to some embodiments.

FIG. 6 depicts an example of using the large multimodal model for processing queries to generate responses according to some embodiments.

FIG. 7 illustrates one example of a computing device according to some embodiments.

### DETAILED DESCRIPTION

Described herein are techniques for a content analysis system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

A system may train a large multimodal model (LMM) to recognize objects in content, such as in images, audio, video, or other types of content. An image may be used for discussion purposes, but other content instances may be used in place of the image. The large multimodal model may receive an image and a text instruction. The text instruction may ask the large multimodal model to recognize objects in the image. The large multimodal model then analyzes the image and the text instruction and outputs a response, such as “The image includes the following objects: 1. Object Name 1, Object Name 2, 3. Object Name 3.”. The object names may be names of the objects, such as a person's name, a name of a food item, a name of a computer type, or other names.

The large multimodal model may be generally trained to recognize objects. However, there may be other objects that a company specifically wants the large multimodal model to be trained to recognize. For example, if a company wants to fine-tune a large multimodal model to recognize specific objects, the system may be trained with images of the specific objects. One problem is that it may be hard to obtain enough images with a specific object from sources, such as the Internet. Also, when training with multiple objects, labeling the dataset manually may cost a large amount of resources when the dataset gets large.

To improve upon the above problem, the system fine-tunes the large multimodal model with higher accuracy using a synthetic dataset that requires a limited number of images of specific objects. The images may be portrait images (e.g., photos, frames of a video, screenshots, etc.) of individual objects. A portrait image may be an individual image that depicts a single object. This object can be a person, but may be other objects, such as an inanimate objects of computers, animated characters, animals, buildings, furniture, electronics, logos, symbols, recipes, dishes, or food items, etc. The image may have different backgrounds, but the portrait image can be considered as a close-up or focused representation of a single subject or object, which can be a person, animal, object, or even a concept.

Then, the system generates synthetic images by combining individual portrait images into a synthetic image. The synthetic images are then used to train the model. The resulting trained model may be more accurate in recognizing the specific object due to the training. Also, the trained model may be better at recognizing multiple objects in a single image (e.g., an image that includes the specific object and other objects) due to the training using the synthetic images. For example, training the model with individual portrait images with the limited dataset may cause the large multimodal model to be trained to output responses for only a single object in an image even if that image includes multiple objects. The training using the synthetic images may train the model to output responses that identify multiple objects in the image. The use of synthetic images may save storage space because the synthetic images are generated from a limited set of portrait images. The initial dataset may be limited, which saves storage space. Also, computing resources are saved because a full dataset of images with portrait images and images with multiple objects does not need to be searched for and retrieved.

### System

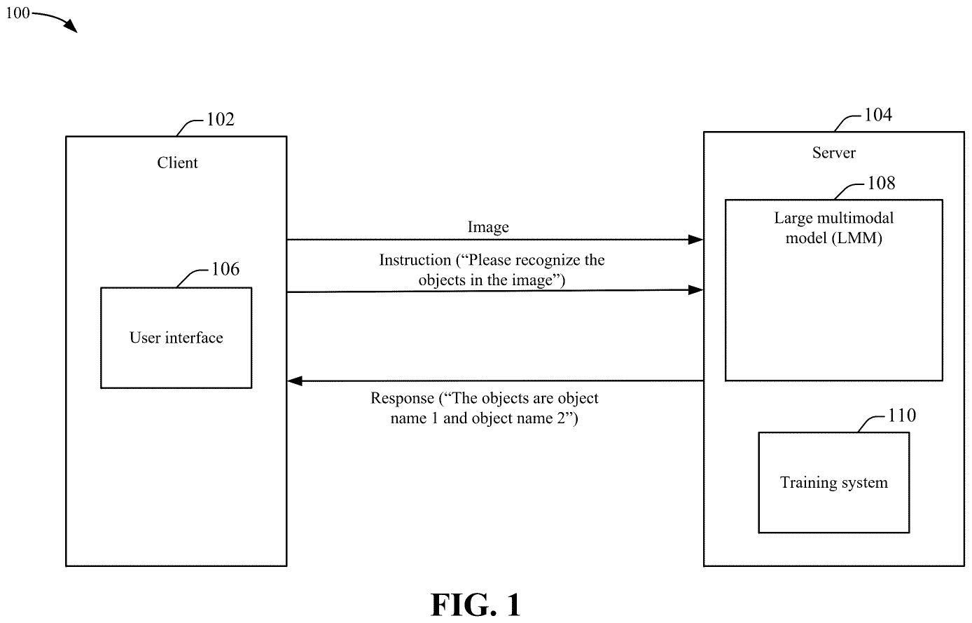

FIG. 1 depicts a simplified system 100 for detecting objects in an image according to some embodiments. System 100 includes a client 102 and a server 104. Although single instances of the client and the server are shown, multiple instances may be appreciated. For example, server 104 may be responding to multiple requests from different clients 102.

Client 102 may be a computing device, such as a smartphone, laptop computer, tablet device, living room device, or other types of devices. Client 102 includes a user interface 106 in which an entity (e.g., a user, program, etc.) may input a query. For example, the query may be a multimodal query that includes multiple modes of input, such as an image and a text instruction. The text instruction includes text that provides instructions, such as the text instruction may ask a large multimodal model 108 to recognize the objects in the image. In this example, the text instruction is “Please recognize the objects in the image”, but other text instructions may be used. The text instruction includes instructions as to what the entity wants to be performed. The image is the content that the entity wants to analyze.

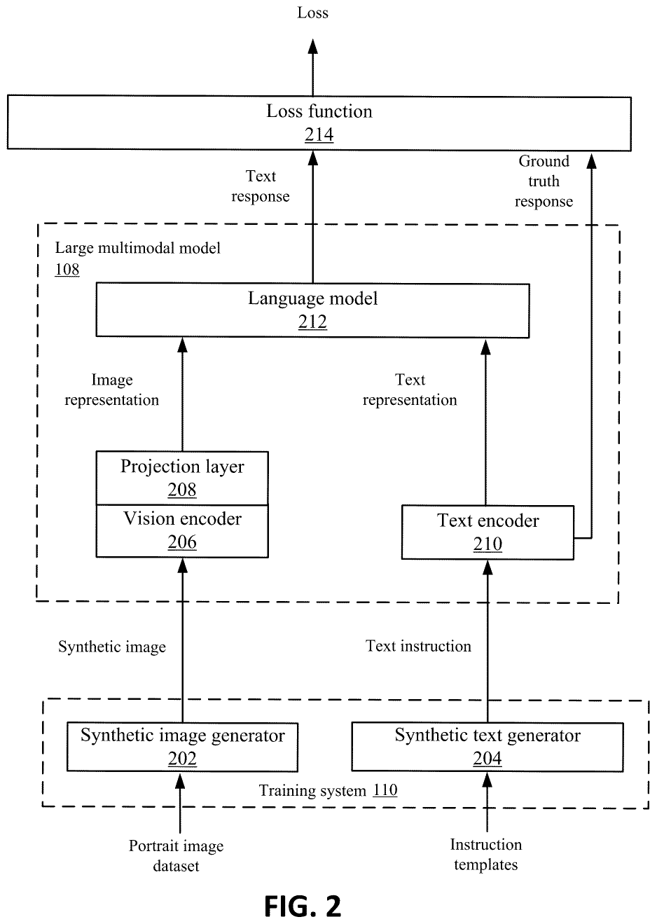

Server 104 receives the image and the text instruction. A large multimodal model 108 may process the image and text instruction to generate a response. The structure of large multimodal model 108 will be described below in FIG. 2. In some embodiments, the text instruction may cause the model to recognize the objects in the image. An example response may be “The objects are object name 1 and object name 2”. The object names may be the names of the people in the image, names of inanimate objects in the image, or other labels. Examples of inanimate objects may be recognizing a food item, dog, computer type, etc. In some embodiments, the names may be names for performers, characters, animated characters, computers, animals, buildings, furniture, electronics, logos, symbols, recipes, dishes, or food items etc. shown in the image. For example, the performers may be actors or actresses in a movie that is being delivered by a content delivery system.

In some cases, large multimodal model 108 may be generally trained to recognize objects. However, a company may want large multimodal model 108 to be fine-tuned to recognize other objects. For example, the company may have a new food item or computer, such as a hamburger or computer model, that the company wants large multimodal model 108 to recognize. Also, the company may have a new performer in a movie that will be added to a content delivery system for delivery to clients, and wants large multimodal model 108 to be fine-tuned to recognize the new performer.

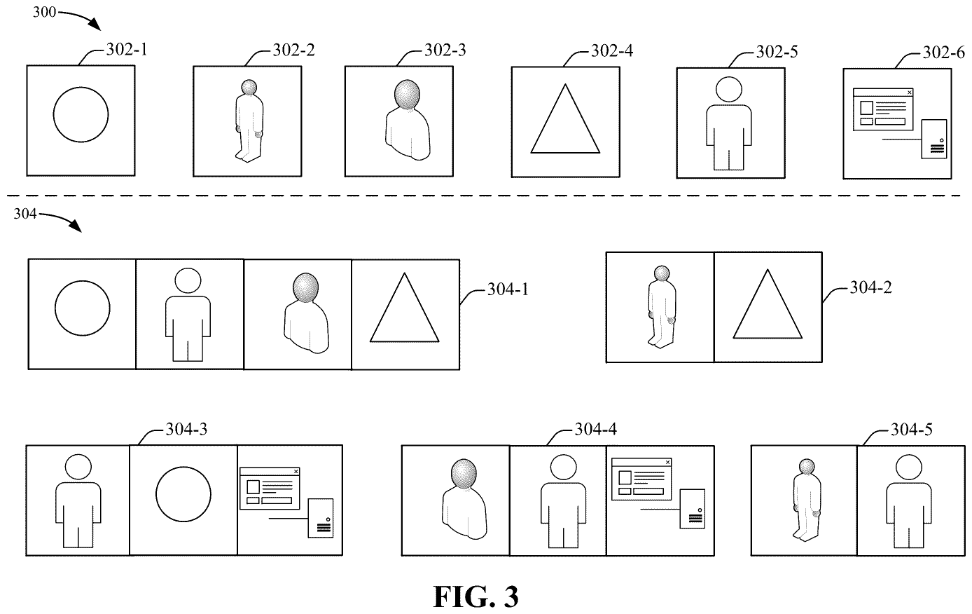

A training system 110 may be used to fine-tune large multimodal model 108 to recognize the specific objects. Training system 110 may determine images of the objects. For example, portrait images of the objects may be determined, such as via a search of sources (e.g., databases, networks, the Internet, etc.). Then, training system 110 generates synthetic images from the portrait images. The synthetic images include multiple individual portrait images in a single image. The synthetic images will be described in more detail below, such as in FIG. 3.

The synthetic images may be used to train large multimodal model 108. The portrait images may also be used with the synthetic images in the training. The training of large multimodal model 108 may adjust parameters (e.g., values, weights, etc.) of large multimodal model 108. The adjusted parameters of large multimodal model 108 may improve the recognition of large multimodal model 108 to recognize the objects in images. The use of the synthetic images may improve the training compared to using the portrait images. For example, if only the individual portrait images are used, the training dataset may not be large enough to sufficiently train the parameters of large multimodal model 108. However, the number of synthetic images that can be generated from the portrait images increases the number of images in the training dataset. Also, by generating synthetic images that include multiple objects, large multimodal model 108 may be trained to recognize multiple objects in an image. It may be possible that training large multimodal model 108 with single portrait images may cause large multimodal model 108 to respond to text instructions to recognize objects in the image with a response that identifies only one of the objects in the image. This may be because the parameters being adjusted are based on recognition of a single object in the portrait images.

### Training System

FIG. 2 depicts a more detailed example of training large multimodal model 108 according to some embodiments. A portrait image dataset and instruction templates may be used to train large multimodal model 108. The portrait image dataset may include individual images of objects in which a user wants to train large multimodal model 108 to recognize. To determine the individual portrait images, a search may be performed with an object name. The search may yield search results that include portrait images. Other methods may also be used to determine portrait images. For example, frames of a video or clip of video may be captured, and the portrait images of the object may be extracted from the frames. For example, the frame may only have the object in it, or a crop of the object is performed. Other methods may also be appreciated.

Individual portrait images may be used because the object name that was used in the search is associated with the portrait image. This can automatically label the portrait image with the object name. The object name will be used in the training process to form the ground truth, which will be discussed below. Also, if an image with multiple objects is used, then this might confuse large multimodal model 108 as to which object is associated with the name. In some embodiments, if an image with multiple objects is retrieved from the search, the target object may be extracted from the image to form a portrait image. However, suppose one raw image includes two objects A and B. When generating synthetic data from this image, as long as both name A and name B are included in the ground truth label, the training will work since the labels are correct for the multiple objects in the synthetic image.

The instruction template may be different templates that can be used for text instructions. The instruction templates are used to generate text instructions to input into large multimodal model 108 to generate responses. One example of an instruction template for the training process includes a question and an answer: “User: Please tell me the names of the objects in the image. <image>; Assistant: {}”. Here, the placeholder image <image> is a special token indicating the existence of the input image, which will be filled in during training. The brackets {} is a placeholder of the response answer of large multimodal model 108 and will be replaced by the actual names of the objects by large multimodal model 108. The response is used during training to compute a loss between the output and the ground truth. Other templates may be used to provide different queries during training.

A synthetic image generator 202 receives the portrait image dataset. Synthetic image generator 202 may generate synthetic images from the portrait image dataset such that the synthetic images may include multiple individual portraits of objects in a single image. Synthetic image generator 202 may generate the synthetic images using different methods. In some embodiments, synthetic image generator 202 may combine the portrait images, such as concatenate the images in one row. However, the images may be combined in other ways, such as vertically, in other structural patterns, etc. Examples of synthetic images are described in FIG. 3. Synthetic image generator 202 may also generate a label for the synthetic image using the names of the objects that are included in the synthetic image. For example, the names of “Object Name 1, Object Name 2, Object Name 3” may be the label if these objects are included in the synthetic image.

Synthetic image generator 202 may also augment the synthetic image. For example, synthetic image generator 202 may change the background of an individual portrait image with a random background. Also, an object from a portrait image may be extracted without the background, and the object is randomly placed into a randomly selected background. Further, the extracted object may also be randomly placed into other backgrounds, such as a texture image. This may further diversify the training dataset and improve the training of large multimodal model 108 to recognize the object with different backgrounds.

A pair of a synthetic image and a text instruction is input into large multimodal model 108. Synthetic text generator 204 may retrieve an instruction template for each synthetic image. In some embodiments, the text instruction template that is selected may be randomly selected. Synthetic text generator 204 may insert the names of the objects from the synthetic image in the instruction template.

Synthetic text generator 204 also generates a ground truth. For example, the ground truth may be a response that is expected from large multimodal model 108. The ground truth may be generated based on the instruction template. For example, the instruction template includes a response template in which names of the objects in the synthetic image can be inserted. An example of the ground truth may be “The object names are: 1. Object Name 1, Object Name 2, Object Name 3.”. The object names may be determined from the labels of object names for the portrait images that were used to generate the synthetic image.

The template is composed with two parts: USER and ASSISTANT. The USER part is the question which is used at the inference time. The ASSISTANT part is the expected answer from large multimodal model 108. When training system 110 is generating an instance of text input, the ground truth labels are inserted to the ASSISTANT part as the answer. The following is an example of the template text:
“USER: Please tell me the names of people in the image. <image>
ASSISTANT: {}”
If the label for this image is “Object Name 1” and “Object Name 2”, the generated text data for training is:
“USER: Please tell me the names of people in the image. <image>
Assistant: Object Name 1, Object Name 2”

A single synthetic image and text instruction will be used to describe the training process with large multimodal model 108. But the training process may use multiple synthetic images and text instructions to adjust parameters of large multimodal model 108. A vision encoder 206 receives the synthetic image. Vision encoder 206 encodes the synthetic image into a representation in a space. For example, vision encoder 206 generates an embedding based on the features of the synthetic image in an embedding space. Different features that are extracted from the synthetic image may generate embeddings in different areas of the embedding space.

Vision encoder 206 may include neural network components that process the synthetic image to extract meaningful features from the visual data. The features are encoded into the representation in a space. An example of the representation may be an array or a list of floating numbers. The length of the array could be from several hundreds to thousands. In some embodiments, an array may be array([0.4316784, 0.28901438, 0.96189958, . . . , 0.87746905, 0.73488661, 0.34667482]).)

A projection layer 208 may include one or more layers that process the image representation. Projection layer 208 may project the image representation into a higher dimensional space that may align with a text representation from text encoder 210. Projection layer 208 may perform different operations to project the image representation. In some embodiments, project layer may not be required.

Text encoder 210 receives the text instruction and generates a text representation in a space. For example, a text embedding in an embedding space is generated. In this case, the text embedding and the image embedding are represented in the same space. Text encoder 210 may include neural network components that process the text instruction to extract features from the text. The text representation represents the extracted features in the space.

A language model 212 receives the image representation and the text representation. Language model 212 includes neural network components that analyze the image representation and the text representation to output a response in text. Language model 212 can receive representations from multiple formats (e.g., multimodal) as input. Language model 212 outputs a response based on the image representation and the text representation. In some embodiments, the response may be the names of objects in the image. In some embodiments, the language model is a neural network that was trained to predict the most likely next word from a set of vocabulary based on a list of tokens as input. For example, suppose the input text is “Every effort moves you”, the model might predict the most likely next word is “toward”, and then feed the text “Every effort moves you toward”, the next predicted word might be “finding”. The process continues until the model outputs an end of sequence token or the maximum output length is reached.

A loss function 214 of training system 110 receives the text response from language model 212 and a ground truth response from text encoder 210. The ground truth response is generated based on the labels from the portrait images that were used to generate the synthetic image. For example, the object names are inserted in the ground truth response. Loss function 214 compares the text response and the ground truth response to determine a difference (e.g., a loss) Different types of losses may be used such as s Mean Squared Error (MSE). The definition is

$$MSE = \frac{1}{N} {\sum }_{i = 1}^{N} {( {y}_{i} - {\hat{y}}_{i} )}^{2} ) ,$$

in which yᵢ is the predicted value and ŷᵢ is the ground truth value. Then, training system 110 may adjust parameters of large multimodal model 108 to minimize the loss. In some embodiments, different parameters may be adjusted. For example, the parameters of language model 212 and projection layer 208 may be adjusted. The parameters of vision encoder 206 and text encoder 210 may be frozen. However, different parameters may be frozen or trained.

The above training process may be repeated with other synthetic images and corresponding text instructions to further adjust the parameters. The process may continue until a condition is met. For example, the entire dataset of synthetic images may be processed. Also, a set number of synthetic images may be processed. Further, the training may be stopped when the loss meets a condition, such as the loss is minimized to a threshold.

The following will now describe examples of synthetic images.

### Synthetic Images

FIG. 3 depicts an example of generating synthetic images according to some embodiments. At 300, individual portrait images of objects are shown. At 304, synthetic images are shown.

Individual portrait images 302-1 to 302-6 (collectively images 302) depict different objects. Each image 302 includes a single object and the objects in the images may be different. For example, image 302-1 may be a circle. Object 302-2 may be an image of a person. Object 302-3 may be another image of a person. For example, the person may be different pictures of different performers. Object 302-4 may be a triangle, object 302-5 may be another person, and object 302-6 may be a computer. Although not shown, images 302 may have different backgrounds. In some embodiments, images 302 may be retrieved, such as from the Internet or other databases, using a search of the object name. Also, multiple portrait images of a single object may be retrieved. For example, multiple portrait images of a performer 1 may be retrieved. Also, multiple images of a type of a computer may be retrieved.

Synthetic images 304-1 to 304-5 may be generated. In some embodiments, synthetic image generator 202 may concatenate individual portrait images 302 in a single row. However, the individual portrait images 302 may be combined in different ways as discussed above. In some embodiments, synthetic image generator 202 may randomly select individual portrait images 302 to form a synthetic image 304. The number of individual portrait images in a synthetic image may also vary.

In this example, synthetic image 304-1 includes portrait images 302-1, 302-5, 302-3, and 302-4. Synthetic image 304-2 includes different portrait images and a different number of portraits images, which is two portrait images 302-2 and 302-4. Synthetic images 304-3, 304-4, and 304-5 include different portrait images and a different number of portrait images also.

The following will now describe the training process with the generation of the training dataset and then the training process.

### Training

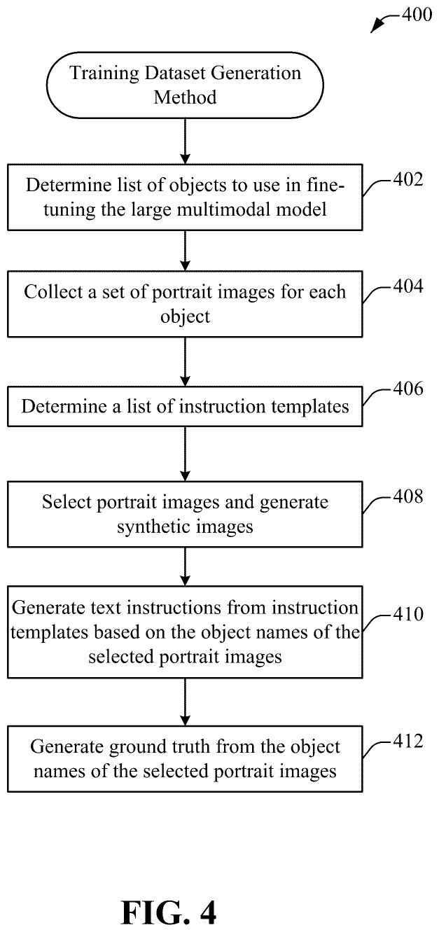

FIG. 4 depicts a simplified flowchart 400 of a method for generating a training dataset according to some embodiments. At 402, training system 110 determines a list of objects to use in fine-tuning the training of large multimodal model 108. The list of objects may include object names, such as Performer 1, Performer 2, circle, computer, etc. In some embodiments, the list of objects may be performer names that may be included in new videos being added to a content delivery system. In other embodiments, objects, such as computers, animated characters, animals, buildings, furniture, electronics, logos, symbols, recipes, dishes, or food items, that should be recognized are included.

At 404, training system 110 collects a set of portrait images 302 for each object. In some embodiments, training system 110 may search a source, such as the Internet or a database (e.g., from internal or external sources). For example, training system 110 may use a search query with the name of each object to retrieve portrait images 302. This search may be performed automatically using the names of the list of objects. The results may be curated to determine images with a single object. Each individual portrait image 302 may have a label from the object name that was used in the search. Also, the label may be received or generated based on analysis of the image.

At 406, training system 110 determines a list of instruction templates. The instruction template may be randomly selected from the list of instruction templates. Also, different instruction templates may be used for different lists of objects. For example, different instruction templates may be used based on performers compared to computers or food items.

At 408, training system 110 selects portrait images and generates synthetic images. Training system 110 may randomly select the portrait images to generate the synthetic images. Also, the synthetic images may include a different number of portrait images. In other embodiments, an algorithm may also be used to select portrait images. For example, portrait images that may be considered more important may be selected and included more often in synthetic images.

At 410, training system 110 generates text instructions from the instruction template based on the object names of the selected portrait images. For example, training system 110 replaces placeholders with values.

At 412, training system 110 generates a ground truth from the object names of the selected portrait images. The ground truth may be the expected text response from large multimodal model 108. For example, the ground truth may be “The object names are Object Name 1, Object Name 2, Object Name 3.”. The object names may be included from the label of the portrait images that were used to generate the synthetic image.

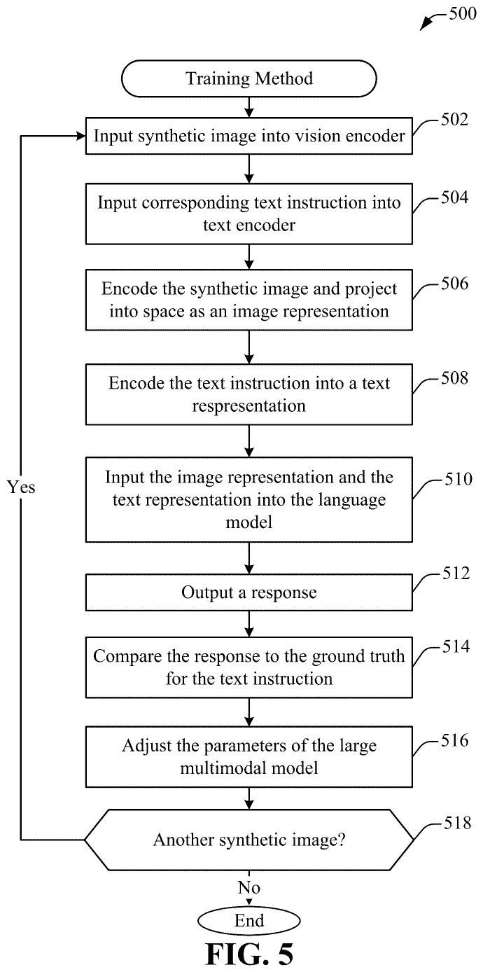

The synthetic images and text instructions may be used to train large multimodal model 108. FIG. 5 depicts a simplified flowchart 500 of a method for training large multimodal model 108 according to some embodiments. At 502, training system 110 inputs a synthetic image into vision encoder 206. The synthetic image may include multiple portrait images that are combined into a single image.

At 504, training system 110 inputs a corresponding text instruction into text encoder 210. The text instruction may have been generated for the synthetic image.

At 506, vision encoder 206 encodes the synthetic image into an image representation and then projection layer 208 projects the result into a space as the projected image representation. The image representation may be projected in a space in which the text representation will be generated. The projection may be based on the parameters that are currently set for projection layer 208.

At 508, text encoder 210 encodes the text instruction into a text representation. The text representation may be a text embedding in the same space as the image representation.

At 510, the image representation and the text representation are input into language model 212, which processes the image representation and the text representation to determine a response. The processing may be based on the parameters that are currently set in language model 212.

At 512, language model 212 outputs a response. The response may be a text response, such as “The object names are Object Name 1, Object Name 4, Object Name 3.”. The response may attempt to identify the objects in the image by object names. Here, the object names are 1, 4, and 3.

At 514, training system 110 compares the response to the ground truth for the text instruction. The ground truth may have been generated based on the object names associated with the individual portrait images that were used to generate the synthetic image. The ground truth may be a text response of “The object names are object Name 1, Object Name 2, Object Name 3.”. Here, the object names are 1, 2, and 3.

At 516, training system 110 adjusts the parameters of large multimodal model 108. For example, training system 110 uses loss function 214 to calculate a loss based on the difference between the response and the ground truth. In the above example, the response identified one object in the image as Object Name 4, but the ground truth identified the object as Object Name 2. This results in a difference or loss between the response and the ground truth. Training system 110 may minimize the loss by adjusting the parameters of large multimodal model 108. For example, training system 110 may adjust the parameters such that large multimodal model 108 may be more likely to output Object Name 2 instead of Object Name 4. In some embodiments, parameters of projection layer 208 and language model 212 are adjusted while parameters of vision encoder 206 and text encoder 210 are frozen.

At 518, training system 110 determines if another synthetic image should be processed. If so, the process reiterates to 502 to input another synthetic image into vision encoder 206 and text instruction into text encoder 210. If another synthetic image is not available, then the training process may end. Training system 110 may output the large multimodal model 108 with the trained parameters. Large multimodal model 108 may then be used to perform inference.

### Processing

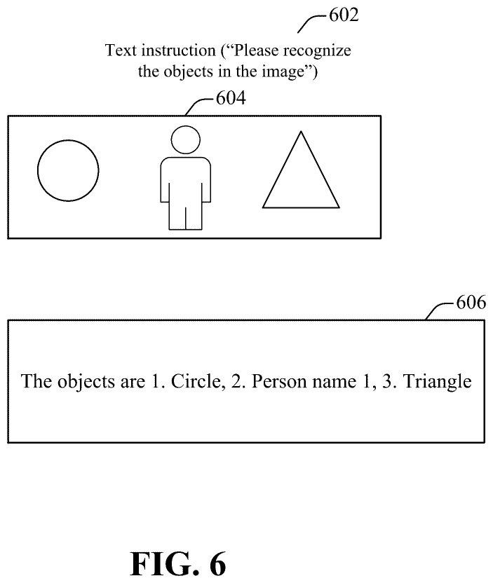

FIG. 6 depicts an example of using large multimodal model 108 for processing queries to generate responses according to some embodiments. At 602, a text instruction is received. For example, the text instruction may be “Please recognize the objects in the image”. In some embodiments, the text instruction may be similar to one of the instruction templates that were used to train large multimodal model 108. But other text instructions may also be received.

At 604, an image is received with objects. The image may be a single image that includes multiple objects. For example, a circle, a person, and a triangle are included in this single image. In other embodiments, an image with a single object may also be used. The objects may be arranged differently in the single image. For example, the objects do not need to be situated in a row. In some embodiments, the image may be a picture that was taken of the three objects, such as a picture three people, or a frame of a video, such as a frame with the three people in it. The three people may be arbitrarily shown in the image as the picture was taken or the frame was captured. Different backgrounds may also be included in the image. In this example, a user may want to know who the objects are in the image.

Large multimodal model 108 may process the text instruction and the image to determine a response. The trained parameters are used to generate the response. For example, at 606, the response may indicate the names of the objects that are determined by large multimodal model 108. For example, the response may be “The objects are 1. Circle, 2. Person Name 1, 3. Triangle.” The response may be used by other systems, such as recommendation or personalization systems. For example, searches for the objects may be performed and the label name that was determined is used in a response to provide the name of the object. The accuracy of the names of the objects improves the services offered by the other systems that use the names by limiting mistakes in the services.

### Conclusion

Accordingly, large multimodal model 108 is trained to recognize objects in images using synthetic images. By combining individual portrait images into synthetic images, the parameters of large multimodal model 108 may be optimally trained to recognize objects in images. The augmentation technique of including multiple portrait images in the synthetic images may improve the processing of large multimodal model 108 to train it to identify multiple objects in an image. The more robust training dataset that can be generated improves the recognition also and saves storage space because the synthetic images are generated from a limited set of portrait images.

### System

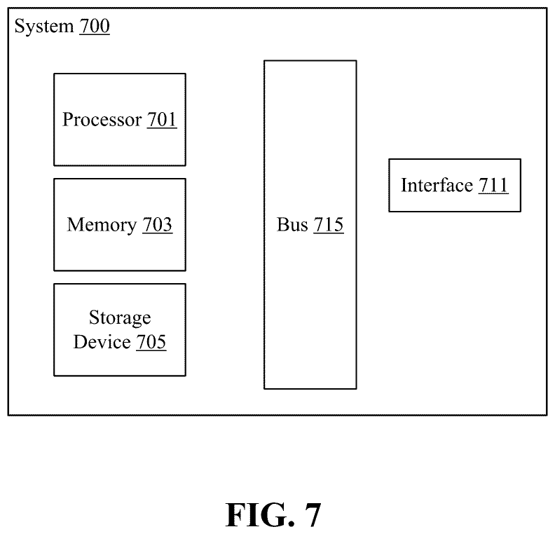

FIG. 7 illustrates one example of a computing device according to some embodiments. According to various embodiments, a system 700 suitable for implementing embodiments described herein includes a processor 701, a memory 703, a storage device 705, an interface 711, and a bus 715 (e.g., a PCI bus or other interconnection fabric.) System 700 may operate as a variety of devices such as server 104, or any other device or service described herein. Although a particular configuration is described, a variety of alternative configurations are possible. Processor 701 may perform operations such as those described herein. Instructions for performing such operations may be embodied in memory 703, on one or more non-transitory computer readable media, or on some other storage device. Various specially configured devices can also be used in place of or in addition to processor 701. Memory 703 may be random access memory (RAM) or other dynamic storage devices. Storage device 705 may include a non-transitory computer-readable storage medium holding information, instructions, or some combination thereof, for example instructions that when executed by the processor 701, cause processor 701 to be configured or operable to perform one or more operations of a method as described herein. Bus 715 or other communication components may support communication of information within system 700. The interface 711 may be connected to bus 715 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
receiving a plurality of images of objects and object names;
generating a plurality of synthetic images, wherein a synthetic image includes a combination of images of objects from the plurality of images of objects;
generating corresponding text instructions and ground truths for the plurality of synthetic images based on respective object names of the combination of images of objects;
inputting a synthetic image from the plurality of synthetic images and a corresponding text instruction into a large multimodal model;
generating, by the large multimodal model, a response using the synthetic image and the corresponding text instruction; and
comparing the response to a corresponding ground truth for the corresponding text instruction to adjust a parameter of the large multimodal model based on a difference between the response and the corresponding ground truth.

2. The method of claim 1, wherein:
an object in the plurality of images of objects is a person, and
the object name for the person is a name of the person.

3. The method of claim 1, wherein receiving the plurality of images of objects comprises:
searching for images based on the object names to determine the plurality of images of objects.

4. The method of claim 1, wherein generating the plurality of synthetic images comprises:
randomly selecting images of objects from the plurality of images of objects to form synthetic images in the plurality of synthetic images.

5. The method of claim 1, wherein synthetic images in the plurality of synthetic images include different numbers of images of objects.

6. The method of claim 1, wherein images of objects in a synthetic image are concatenated in a row.

7. The method of claim 1, wherein images of objects in a synthetic image are arranged in a structural pattern.

8. The method of claim 1, wherein images of objects in a synthetic image are altered.

9. The method of claim 1, wherein an image of objects in the images of objects includes a single object.

10. The method of claim 1, wherein generating corresponding text instructions and ground truths comprises:
determining an instruction template;
inserting corresponding object names for objects of images in a synthetic image into the instruction template to form a corresponding text instruction; and
generating the corresponding ground truth for the corresponding text instruction using the corresponding object names.

11. The method of claim 1, wherein inputting the synthetic image from the plurality of synthetic images and the corresponding text instruction into the large multimodal model comprises:
inputting the synthetic image into a vision encoder to generate an image representation in a space; and
inputting the corresponding text instruction into a text encoder to generate a text representation in the space.

12. The method of claim 11, further comprising:
inputting the image representation and the text representation into a language model to generate the response.

13. The method of claim 12, further comprising:
using a projection layer to project the image representation into the space with the text representation to generate a projected image representation; and
inputting the projected image representation into the language model.

14. The method of claim 1, wherein comparing the response to the corresponding ground truth to the corresponding text instruction to adjust the parameter of the large multimodal model comprises:
determining a loss based on a difference between the response and the corresponding ground truth; and
adjusting the parameter based on the loss.

15. The method of claim 14, further comprising:
continuing to input a synthetic image from the plurality of synthetic images and a corresponding text instruction into a large multimodal model;
continuing to generate, by the large multimodal model, a response;
continuing to compare the response to a corresponding ground truth for the corresponding text instruction to adjust a parameter of the large multimodal model until a condition is met.

16. The method of claim 1, further comprising:
receiving a request of an image with a plurality of objects and a text instruction;
analyzing the request using the large multimodal model with the adjusted parameter; and
outputting a response of a plurality of object names for the plurality of objects.

17. A non-transitory computer-readable storage medium having stored thereon computer executable instructions, which when executed by a computing device, cause the computing device to be operable for:
receiving a plurality of images of objects and object names;
generating a plurality of synthetic images, wherein a synthetic image includes a combination of images of objects from the plurality of images of objects;
generating corresponding text instructions and ground truths for the plurality of synthetic images based on respective object names of the combination of images of objects;
inputting a synthetic image from the plurality of synthetic images and a corresponding text instruction into a large multimodal model;
generating, by the large multimodal model, a response using the synthetic image and the corresponding text instruction; and
comparing the response to a corresponding ground truth for the corresponding text instruction to adjust a parameter of the large multimodal model based on a difference between the response and the corresponding ground truth.

18. The non-transitory computer-readable storage medium of claim 17, wherein inputting the synthetic image from the plurality of synthetic images and the corresponding text instruction into the large multimodal model comprises:
inputting the synthetic image into a vision encoder to generate an image representation in a space; and
inputting the corresponding text instruction into a text encoder to generate a text representation in the space.

19. The non-transitory computer-readable storage medium of claim 17, further operable for:
inputting the image representation and the text representation into a language model to generate the response.

20. An apparatus comprising:
one or more computer processors; and
a computer-readable storage medium comprising instructions for controlling the one or more computer processors to be operable for:
receiving a plurality of images of objects and object names;
generating a plurality of synthetic images, wherein a synthetic image includes a combination of images of objects from the plurality of images of objects;
generating corresponding text instructions and ground truths for the plurality of synthetic images based on respective object names of the combination of images of objects;
inputting a synthetic image from the plurality of synthetic images and a corresponding text instruction into a large multimodal model;
generating, by the large multimodal model, a response using the synthetic image and the corresponding text instruction; and
comparing the response to a corresponding ground truth for the corresponding text instruction to adjust a parameter of the large multimodal model based on a difference between the response and the corresponding ground truth.
